(19) United States
(12) Patent Application Publication
(10) Pub. No.: US 2003/0186208 A1
(43) Pub. Date: Oct. 2, 2003

(54) System and method for learning foreign language conversation utilizing peer-to-peer matching in an online virtual community

(76) Inventors: Sayling Wen, Taipei (TW); Zechary Chang, Taipei (TW); Pinky Ma, Beijinh (CN)

Correspondence Address: BIRCH STEWART KOLASCH & BIRCH, PO BOX 747, FALLS CHURCH, VA, 22040-0747, US

(21) Appl. No.: 10/005,814

(22) Filed: Dec. 7, 2001

(51) Int. Cl. G09B 3/00

(52) U.S. Cl. 434/350

(57) ABSTRACT

A system and method for learning foreign language conversation utilizing peer-to-peer matching in an online virtual community. Making use of the diversity of the members in an online community, the invention provides an instant peer-to-peer matching service for foreign language conversation. The system includes: a central signal monitoring module; a member control module; a member profile database; a tutor certification module; a certification question database; an instant matching module; and a connection redirecting module. The methods include the following: starting a browse and control interface and sending the user's login requests; instant peer-to-peer matching according to the member's personal profile and portfolio; redirecting the connection from a student to a tutor according to the matching results; and saving the connection records to the member profile database.

### FIELD OF THE INVENTION

The invention relates to a system and method for learning foreign language conversation utilizing peer-to-peer matching in an online virtual community. More specifically, the invention relates to a system and method used on the network for learning foreign language conversation utilizing peer-to-peer matching in an online virtual community.

### BACKGROUND OF THE INVENTION

The traditional method of teaching foreign language conversation has almost always been in a face-to-face setting, confined by location and time. This traditional method not only provokes a feeling of awkwardness and anxiety in students because of the face-to-face setting, but also unnecessarily causes the slower learners to worry about having insufficient privacy or not being able to keep up. These effects can further hinder the students' learning curve and willingness to learn.

However, with the rapid development of the network, more and more people have realized that most people prefer not to learn in a face-to-face setting; hence the increase in the number of websites providing online tutoring for foreign language conversation. However, further studies revealed that most of these websites teach through a consulting service, hiring the same teachers, and utilizing a fixed set of materials. This passive learning process not only bores the students in the long run, but also lacks the interaction and authenticity that a foreign language conversation education brings. Students are often restricted in the choice of teachers and do not have the opportunity to converse with other students in this setting with this method. The one-on-one learning environment has also been shown in past studies to be very ineffective compared to any group learning activities (such as cooperative learning and competitive learning.) The combined effects of the above points lead to a lack of student interest in participating in learning foreign language conversation online. Even if one does participate in the online program, the overall effectiveness of it is rather limited because of the program's lack of diversity and liveliness.

### SUMMARY OF THE INVENTION

The invention discloses a system and method for learning foreign language conversation utilizing peer-to-peer matching in an online community that overcomes the limitations of the above-mentioned method. The primary object of the invention is to utilize the diversity of the members on an online virtual community to allow each and every user to be matched instantly with another user of common interests and to engage in a foreign language conversation. The online tutor certification service allows qualified users who are interested in teaching foreign language conversation online to be placed for teaching online users. The instant matching of the invention allows members to directly communicate with other members of the same community while enjoying the diversity that the network brings to the realm of teaching and learning.

To achieve the above objects, the system of the invention for learning foreign language conversation utilizing peer-to-peer matching includes, but is not limited to, the following: one central signal monitoring module; one member control module; one member profile database; one tutor certification module; one certification question database; one instant matching module; and one connection redirecting module.

The methods of the invention for learning foreign language conversation utilizing peer-to-peer matching include, but are not limited to, the following: starting a browse and control interface and sending the user's login requests; instant peer-to-peer matching according to the member's personal profile and portfolio; redirecting the connection from a student to a tutor according to the matching results; and saving the connection records to the member profile database.

The invention of a system and method for learning foreign language conversation utilizing peer-to-peer matching in an online community overcomes the constraints of location and time of traditional methods by building its systems on the network. The invention eliminates any privacy issues and anxiety that in the past has worried students in a face-to-face setting.

In addition, the unique characteristics of an network virtual community broaden and diversify the population of both teachers and students, so members have the freedom to choose. By conversing with different members in each session, every session is a fresh experience for the users, thereby increasing the users' willingness to learn and improving the results. Instant matching allows each and every member to engage in a real-time foreign language conversation with his/her preferred user about a topic of common interest, thus further stimulating the member's interest in learning.

The invention provides a strict tutor certification system capable of selecting the most qualified of all users to undertake the role of a tutor. The invention also allows every user to take control of his or her own learning progress through the member portfolio, thus making the most of this online interactive learning program for foreign language conversation.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

The specific details of the contents and techniques of the invention are described with figures hereinafter:

### BRIEF DESCRIPTION OF THE DRAWINGS

The invention will become more fully understood from the detailed description of given hereinafter. However, the drawings are for the purpose of illustration only, and thus are not limitative of the invention, wherein:

FIG. 1 shows a functional block diagram of a system and method for learning foreign language conversation utilizing peer-to-peer matching in an online virtual community as proposed by the invention.

FIGS. 2-a to 2-c show an overall flow chart for a system and method for learning foreign language conversation utilizing peer-to-peer matching in an online virtual community.

FIG. 3 is an illustration of a possible embodiment of the browse and control interface and the interactive chat window of the invention of a system and method for learning foreign language conversation utilizing peer-to-peer matching in an online virtual community.

### DESCRIPTION OF THE PREFERRED EMBODIMENT

The invention discloses a system and method for learning foreign language conversation utilizing peer-to-peer matching in an online virtual community. Specifically, the invention aims to overcome the limitations of traditional methods of learning foreign language that is confined by location, time and various other difficulties by proposing a system and method for learning foreign language conversation utilizing peer-to-peer matching in an online virtual community. The virtual community, being constructed on the network, broadens and diversifies the population of both tutors and students. Instant matching allows each and every member to engage in real-time foreign language conversation with other users about topics of common interest, thereby vastly augmenting the students' willingness to learn, and enhancing the results. For members who wish to become an online tutor, the invention provides a strict tutor certification system capable of selecting the most qualified of all users to undertake the role of a tutor. The invention also allows every user to take control of their own learning progress through the member portfolio, thus making the most of this online interactive learning program for foreign language conversation.

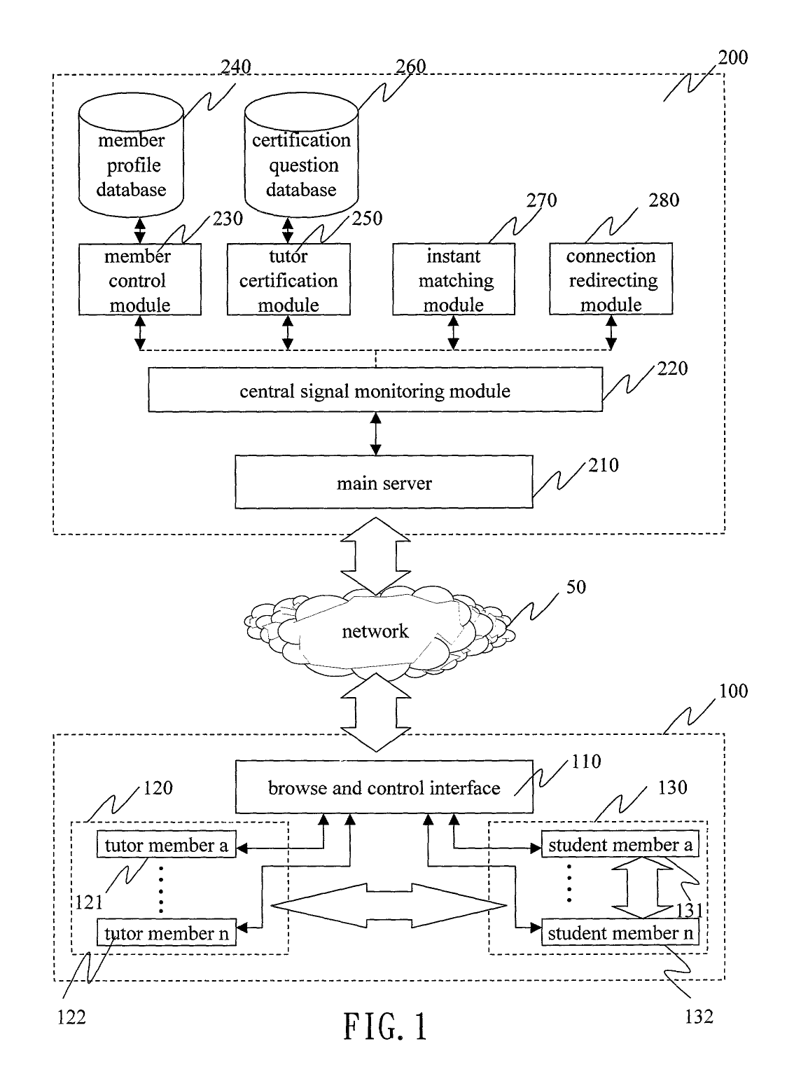

A preferred embodiment of the invention is described hereinafter with reference to the above-mentioned figures. FIG. 1 shows a functional block diagram of a system and method for learning foreign language conversation utilizing peer-to-peer matching in an online virtual community as proposed by the invention. The figure, described hereinafter, summarizes the basic framework of the invention.

A system, as proposed by the invention, for learning foreign language conversation utilizing peer-to-peer matching in an online virtual community uses the main server (210), located on the server side (200), to process all of the service requests from members on the client side (100), as well as to perform tasks such as instant matching, and managing member portfolios. Through the use of the browse and control interface (110) of any digital terminal device with voice and text communication capabilities, all members on the client side (100) can link to the main server (210) of the system to use all of the provided services. Communication between the client side and the server side is achieved via the network (50). Based on their different intentions, members may propose different registration requests. The members of the virtual community can be categorized into two groups: one is the tutor users group (120), comprised of tutor members a (121) to n (122); another is the student users group (130), comprised of student members a (131) to n (132).

All the tasks sent to the main server (210) are performed by separate functional modules working in conjunction with one another. The system is comprised of the following functional modules: 1. The central signal monitoring module (220): all of the tasks that the system performs are interconnected and controlled by this module. It is mainly responsible for transmitting and receiving signals to and from other modules and monitoring and recording user controls and actions; 2. The member control module (230): this module is responsible for monitoring users' identities and personal profiles, including adding new members' personal profiles, modifying and deleting personal profiles of existing users, login verification and classifying registration requests; 3. The member profile database (240): the purpose of this database is to maintain and provide all member personal profiles. It is also responsible for searching and retrieving member files for use by other modules or processes; 4. The certification module (250): this module performs an online tutor diagnostic test for individuals wishing to become a member of the tutors user group, analyzes the results, then places the users according to their qualifications; 5. The certification question database (260): this database provides the questions for use in the tutor diagnostic test by randomly choosing questions from the database; 6. The instant matching module (270): this module matches and places members in the same virtual community according to the members' personal profiles and portfolios; 7. The connection redirecting module (280): when matching results are produced, this module redirects the connection between matched members of the same virtual community on the client side (100) so that a direct connection is established between the matched members. The members can then communicate through either voice or text, and perform a real-time peer-to-peer tutoring session.

The browse and control interface (110) used on the client side (100) can reside on any digital device with voice and text communication capabilities. The platforms for such an interface can be chosen from at least the following: personal computer (PC), note book (NB), and personal digital assistant (PDA).

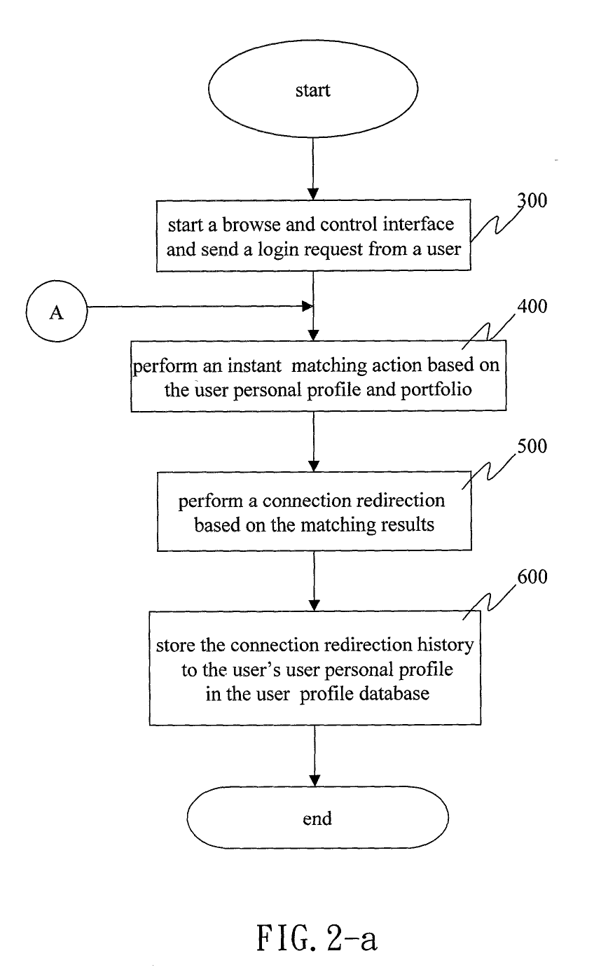

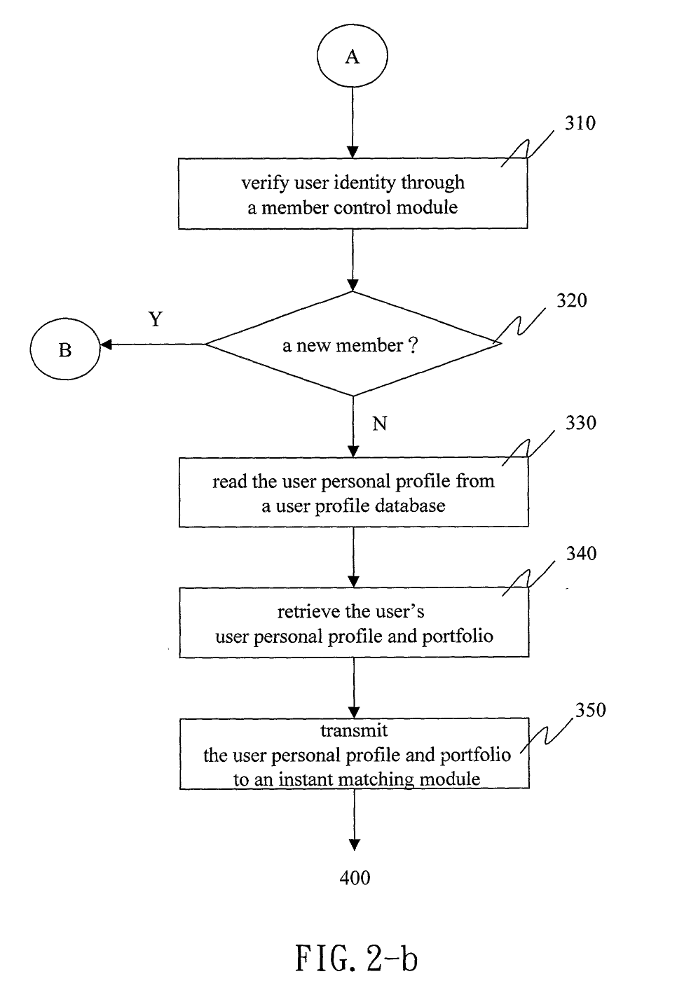

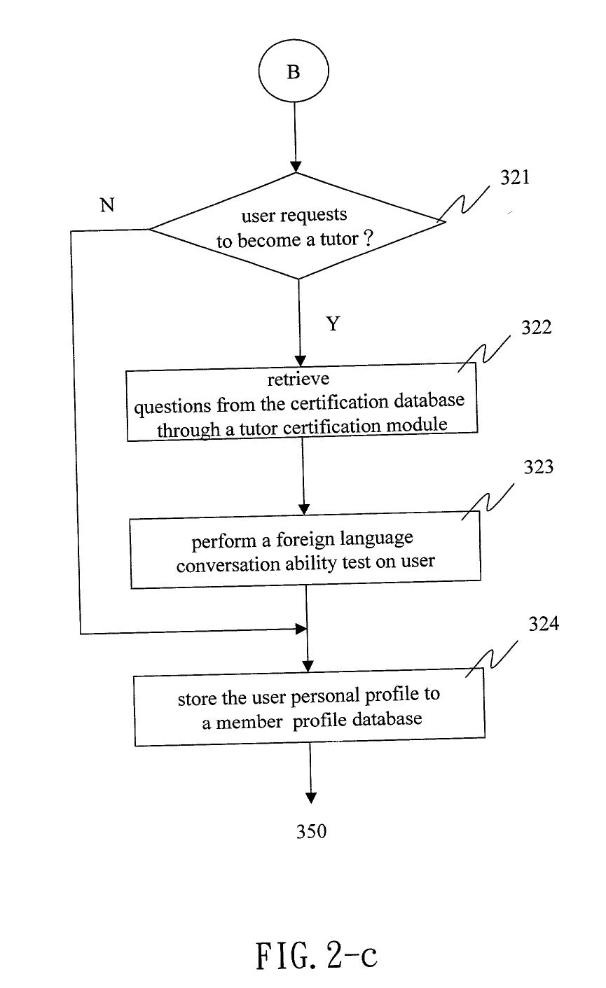

FIG. 2-a shows an overall flow chart for a system and method for learning foreign language conversation utilizing peer-to-peer matching in an online virtual community, described hereinafter. First, a user on the client side (100) starts the browse and control interface and sends a login request (300) to the main server (210.) Details of the methods of processing the login requests are described in procedure A in FIG. 2-b. Instant matching (400) is performed according to the member's personal profile and portfolio. The matching results then allow the system to further redirect the connections to establish direct connections between the matched members of an online community, and start an online tutoring session (500.) Data are taken from the session and are stored into the members' personal profile database (600) along with the connection redirection history when a member leaves the system and services are terminated.

FIG. 2-b shows a flow chart for a system and method for learning foreign language conversation utilizing peer-to-peer matching in an online virtual community, mainly describing the detailed procedures that are performed when a user sends a login request through the browse and control interface. When procedure A is performed, the system verifies the user identity (310) through the member control module (230.) First the system searches for the user in the member profile database (240) to determine whether the user is a new member (320.) If the user is not a new member, meaning that the user has logged in before as a member of a virtual community, then the user's file is read (330) from the member profile database (240.) The user's portfolio is then retrieved (340) and sent along with the user's personal profile to an instant matching module (270) to perform instant peer-to-peer matching. When the above-mentioned procedures are complete, the process returns to step 400 of FIG. 2-a. If the user is a new member and does not exist in the member profile database, then the process moves to procedure B.

FIG. 2-c shows a flow chart for the invention of a system and method for learning foreign language conversation utilizing peer-to-peer matching in an online community, mainly describing the details of procedure B, performed by the system when the user is a new member. When procedure B is performed, the system first determines whether the login request is a request to become a tutor (321). If so, the system then performs a certification diagnostic test on the user. The tutor certification module (250) first retrieves questions (322) from the question database for a tutor diagnostic test (260,) which randomly selects the questions, then performs a tutor diagnostic test (323) on the user. When the user passes the test, the module then places the user according to the results, and records the placement result, along with the member's personal profile (including: name, age, gender, occupation, interests and hobbies, and chat preferences) in the member profile database (240) before returning to the main flow chart at step 350. If the user requests to login as a student (321), then the system moves on to step 324 and stores the user-entered information into the member profile database 240.

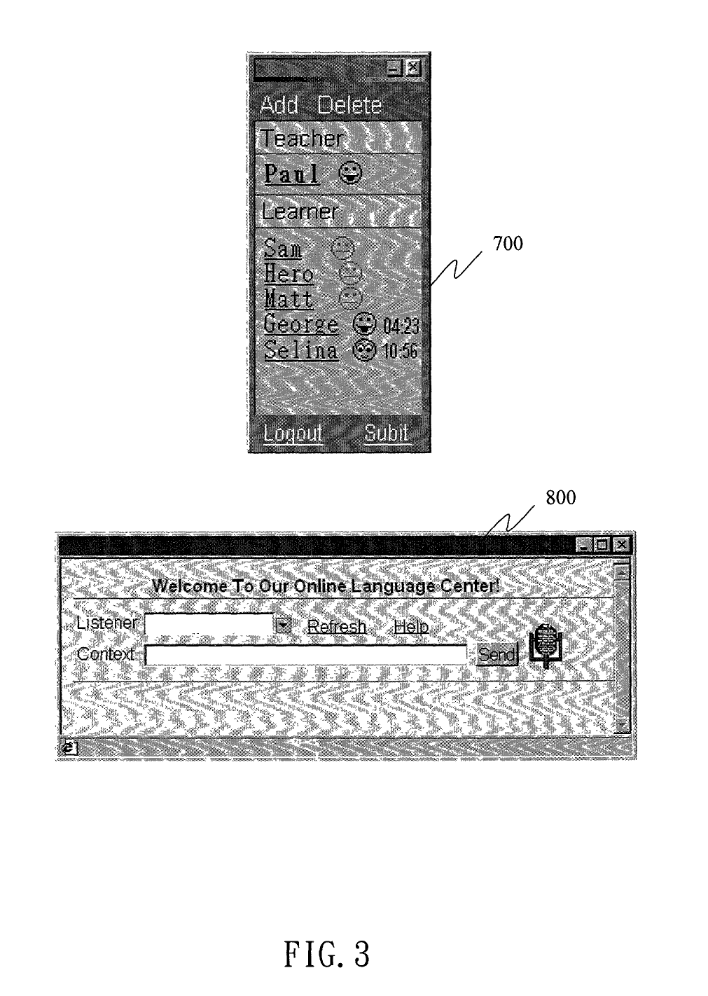

FIG. 3 is an illustration of a possible embodiment of the browse and control interface and the interactive chat window of the invention of a system and method for learning foreign language conversation utilizing peer-to-peer matching in an online virtual community. The browse and control interface window illustration (700) shows that the window includes, but is not limited to, the following functions available for the user during real-time conversations: a contact list management function (e.g. add or delete users), a display of real-time status of members of the same virtual community, a display of connection times for each member of the virtual community, and login/logout controls. The interactive chat window illustration (800) allows the member to select any other member of the virtual community to communicate through either voice messages or text message by selecting the proper option in a pull-down menu. The window also provides text boxes to compliment direct communication through speech. All text messages are recorded. When a user chooses to log out of the system using the browse and control interface window (700), the system records all data from the user's present session into the portfolio to be referenced in future sessions.

The invention being thus described, it will be obvious that the same may be varied in many ways. Such variations are not to be regarded as a departure from the spirit and scope of the invention, and all such modifications as would be obvious to one skilled in the art are intended to be included within the scope of the claims hereinafter.

What is claimed is:

1. A system for learning foreign language conversation utilizing peer-to-peer matching in an online community constructed on the network. A main server performs real-time controlling and monitoring over the entire system, and through a browse and control interface on the client side, a real-time online tutoring session can be set up between multiple matched users of the same virtual community. The system comprises:
One central signal monitoring module, used to send and receive signal between modules and monitor user controls. When a user logs in through a browse and control interface on the client side, the module is to produce a control and monitor signal in order for other modules to perform their functions;
One member control module, used to monitor user identity and personal profile. The module is to verify the user's identity and transfer user personal profile upon receiving the said control and monitor signal from the said central signal monitoring module, and produce an identity verification request signal;
One member profile database, used to provide relevant personal profile about the user. Upon receiving the said identity verification request signal from the said member control module, the database performs a search on the user personal profile, produces one status verification result signal, sends back one user personal profile search result, while at the same time determining whether or not to send a tutor certification signal;
One tutor certification module, used to perform an instant online tutor certification test for foreign language conversation ability on individuals wishing to become a member of the tutors user group upon receiving the said tutor certification signal, send a questions retrieval request signal, and return a tutor certification test result signal after the tutor certification test;
One certification questions database, used to provide questions needed for the tutor certification test, connect with the said tutor certification module, retrieve questions from the certification questions database upon receiving the said questions retrieval request signal and send the questions for tutor certification purposes;
One instant matching module, used to perform instant matching on the online users. The module is to receive the said status verification result signal, match users of the same virtual community based on search results and produce a student and tutor matching result signal based on the matching results; and
One connection redirecting module, used to establish a direct connection between users based on the match results in order to initiate a tutoring session.

2. The system as in claim 1 wherein said client side refers to digital devices capable of voice and text communication.

3. The system as in claim 1 wherein said browse and control interface includes at least contact list management functions, real-time display of the status of virtual community members, display of connection time of each virtual community member, and login and logout functions.

4. The system of claim 1 wherein that the members on the client side can be categorized in at least the following groups:
A tutors user group, comprised of existing members deemed qualified by the tutor diagnostic test; and
A students user group, comprised of existing members.

5. The system of claim 1 wherein the said central signal monitoring module performs the function of, but is not limited to, inter-module information and signal exchange, status management and session history recording of individual users on the client side.

6. The system of claim 1 wherein the tutor certification test questions are selected randomly from the tutor diagnostic questions database.

7. The system of claim 1 wherein the instant matching module performs instant matching between online users based on preset information.

8. The system of claim 7 wherein the preset information used in the instant matching process includes at least member profiles and portfolios.

9. The system of claim 8 wherein the member profile includes, but is not limited to, name, gender, age, occupation, hobbies and interest, and chat preferences.

10. The system of claim 1 wherein the connection redirection relates to an action of establishing direct connection between the tutors and students according to the matching results.

11. The system of claim 1 wherein the tutoring session proceed at least via both speech and text communication.

12. A method for learning foreign language conversation utilizing peer-to-peer matching in an online virtual community constructed on the network. A main server performs real-time controlling and monitoring over the entire system, and through a browse and control interface on the client side, a real-time online tutoring session can be set up between multiple matched users of the same virtual community. The method comprising:
starting a browse and control interface and sending the login registration requests of a user;
performing instant matching according to members' personal profiles and portfolios;
performing connection redirecting between tutors and students to establish tutoring sessions based on the matching results; and
storing the connection redirection history to the members' personal profile in the member profile database.

13. The method of claim 12 wherein the client side refers to any digital device capable of voice and text communications. Devices include, but are not limited to: personal computers (PC), note books (NB), and personal digital assistant (PDA).

14. The method of claim 12 wherein the browse and control interface comprises of, but is not limited to, contact list management functions, real-time display of the status of virtual community members, display of connection time of each virtual community member, and login and logout functions.

15. The method of claim 12 wherein the login and registration requests at least includes the following two types: a tutor login and registration request and a student login and registration request.

16. The method of claim 12 wherein the using the browse and control interface to send login and registration requests further includes:
verifying the user's identity through the member control module;
determining whether the user is a new member;
reading the user personal profile from a member profile database;
fetching the member personal profile and portfolio; and
sending the member personal profile and portfolio to a instant matching module.

17. The method of claim 16 wherein the procedure of determining whether the user is a new member further includes the following steps:
determining whether the login request is a request to become a tutor;
reading a questions database for diagnostic tests through a tutor certification module;
performing a diagnostic test for foreign language conversation ability and placing the user according to the results; and
storing the user personal profile to a member profile database.

18. The method of claim 17 wherein the questions database for diagnostic tests selects questions in a random fashion.

19. The method of claim 17 wherein the instant matching module matches the tutor members to student according to the member personal profile and portfolio.

20. The method of claim 19 wherein the member personal profile includes, but is not limited to, the following: name, age, gender, occupation, interests and hobbies, and chat preferences.

21. The method of claim 12 wherein the connection redirection relates to an action of establishing direct connection between the tutors and students according to the matching results.

22. The method of claim 12 wherein the tutoring session proceed at least via both speech and text communication.
